(19) United States
(12) Patent Application Publication
(10) Pub. No.: US 2008/0184704 A1
(43) Pub. Date: Aug. 7, 2008

(54) Tubular moulding

(75) Inventors: Stefan Bock, Grossostheim (DE); Roland Schray, Ingersheim (DE); Thomas Rosch, Linsengericht-Grossenhausen (DE)

Correspondence Address: Edward J. Timmer, P.O. Box 770, Richland, MI, 49083, US

(73) Assignees: ElringKlinger AG; Veritas AG

(21) Appl. No.: 12/009,664

(22) Filed: Jan. 22, 2008

Related U.S. Application Data
(63) Continuation of application No. PCT/EP2007/009869, filed on Nov. 15, 2007.

(30) Foreign Application Priority Data
Nov. 17, 2006 (DE) 10 2006 054 268.1

(51) Int. Cl. B29C 49/06; B29D 23/00; B29C 49/20; F02B 29/04

(52) U.S. Cl. 60/599; 428/36.91; 428/36.1; 264/512; 264/259; 264/261; 264/513

(57) ABSTRACT

In order to provide a tubular moulding with a wall, which has high compressive strength and high mechanical stability with good temperature resistance and good chemical resistance, it is proposed that the wall comprises a composite, which comprises a plastics material layer, which is formed from a material containing a fluoropolymer material, and a reinforcement layer.

### RELATED APPLICATION

This application is a continuation application of PCT/EP2007/009869 filed Nov. 15, 2007, the entire specification of which is incorporated herein by reference.

### FIELD OF DISCLOSURE

The present invention relates to a tubular moulding with a wall.

### BACKGROUND

Tubular mouldings made of plastics material are used, for example, as a cold-side charge-air line between a charge-air outlet of an intercooler and a charge-air inlet of an internal combustion engine with an exhaust gas turbocharger to supply the charge-air cooled in the intercooler to the internal combustion engine.

### SUMMARY OF THE INVENTION

The present invention is based on the object of providing a tubular moulding with a wall, which has high compressive strength and high mechanical stability with good temperature resistance and good chemical resistance.

This object is achieved according to the invention in a tubular moulding with the features of the preamble of claim 1 in that the wall comprises a composite, which comprises a plastics material layer, which is formed from a material containing a fluoropolymer material, and a reinforcement layer.

Since the wall comprises a plastics material layer containing a fluoropolymer material, the tubular moulding has high chemical resistance and good temperature resistance.

Since the wall comprises a reinforcement layer, the tubular moulding has good pressure resistance and high mechanical strength.

Since the plastics material layer and the reinforcement layer are combined to form a composite, the tubular moulding is easy to handle and assemble and extremely robust and not susceptible to breaking.

In a preferred configuration of the invention it is provided that the reinforcement layer at least partially surrounds the plastics material layer.

The plastics material layer preferably forms the innermost layer of the composite, which surrounds the interior of the tubular moulding and comes into contact with the fluid that is guided through the tubular moulding.

The plastics material layer is preferably self-supporting, in particular configured as a self-supporting plastics material tube.

The reinforcement layer is preferably also configured to be self-supporting, preferably as a self-supporting reinforcement tube or as a self-supporting reinforcement hose.

In a preferred configuration of the invention it is provided that the reinforcement layer comprises a support hose.

It may furthermore be provided that the reinforcement layer comprises a woven fabric, a hosiery fabric, a knitted fabric, a tangle fabric or braided fabric or a winding.

In particular, the reinforcement layer may comprise a woven, hosiery, knitted or wound support hose.

The reinforcement layer is preferably configured from fibres, which withstand the temperatures during production of the tubular moulding and during operation thereof. In particular, the reinforcement layer may contain a fibre glass material, a carbon fibre material, an aramid fibre material and/or a fibre material made of a thermoplastic plastics material.

In order to produce a close material-uniting connection between the plastics material layer and the reinforcement layer, a connecting layer may be arranged between the plastics material layer and the reinforcement layer.

This connecting layer preferably contains a thermoplastic plastics material.

It may be provided, in particular, that the connecting layer contains a fluorothermoplastics material, in particular PFA (perfluoroalkoxy copolymer), FEP (perfluoroethylenepropylene copolymer), MFA (tetrafluoroethylene perfluoromethylvinylether) or modified polytetrafluoroethylene (PTFE).

A “modified polytetrafluoroethylene” is taken to mean here a polytetrafluoroethylene-like substance, in which the molecular structure of the polytetrafluoroethylene (PTFE) has been chemically modified in that, apart from tetrafluoroethylene, a further, also perfluorinated monomer is incorporated in the molecule chain, so the fluoro atoms of the PTFE are partially replaced by substituents.

The chemical composition and production of “modified PTFE” are described, for example, in EP 0 041 687 A1, EP 0 931 798 A1 or the U.S. Pat. No. 6,013,700.

So that the tubular moulding has adequate flexibility to be able to compensate relative movements between its two ends, it is favourable if the moulding has at least one flexible zone.

To provide the desired shape flexibility of the flexible zone of the moulding, it may in particular be provided that the flexible zone comprises an undulating region, preferably a bellows arrangement.

Furthermore, the moulding may also comprise at least one dimensionally stable, rigid zone.

The rigid, dimensionally stable zone of the moulding may have at least one curved portion.

The tubular moulding according to the invention may basically be produced in any manner, for example by an injection method.

The tubular moulding is, however, preferably blow-moulded.

The higher the forming temperature is selected to be, the lower the memory effect in the formed moulding, i.e. the reforming tendency of the formed moulding during heating.

It is particularly favourable therefore if the moulding is moulded at a temperature above the crystallite melting temperature of the starting material of the plastics material layer.

The plastics material layer may, for example, be formed from pure polytetrafluoroethylene and/or modified polytetrafluoroethylene.

As an alternative to this, it may also be provided that the plastics material layer is formed from a polytetrafluoroethylene compound and/or from a modified polytetrafluoroethylene compound, i.e. from a mixture of polytetrafluoroethylene or modified polytetrafluoroethylene and at least one organic or inorganic filler.

To dye the moulding black, it may in particular be provided that the polytetrafluoroethylene compound or the modified polytetrafluoroethylene compound contains a black pigment, preferably carbon black.

The moulding according to the invention is preferably thermally stable at an operating temperature of at least 200° C., preferably at least 250° C.

It is furthermore advantageous if the moulding according to the invention is mechanically stable at an internal operating pressure of at least 2 bar, preferably at least 2.5 bar.

The composite formed from the plastics material layer and the reinforcement layer may extend over the entire length of the moulding according to the invention.

As an alternative to this, it may also, however, be provided that the moulding has at least one composite portion, in which the reinforcement layer and the plastics material layer are connected to one another in a rigid bond, and at least one non-composite portion, in which the reinforcement layer and the plastics material layer are not connected to one another in a rigid bond.

With a configuration of this type of the moulding, the reinforcement layer is moveable in the non-composite portion relative to the plastics material layer, so the moulding in the non-composite portion may have an increased flexibility.

Owing to the rigid bond between the reinforcement layer and the plastics material layer in the composite portion, good support of the plastics material layer in the radial direction and in the axial direction is, however, nevertheless achieved in the composite portion.

It may in particular be provided, that, in at least one non-composite portion, the reinforcement layer loosely surrounds the plastics material layer.

In a preferred configuration of the invention it is provided that the moulding has at least two composite portions, between which a non-composite portion is arranged.

It may in particular be provided that the reinforcement layer of a first composite portion and the reinforcement layer of a second composite portion are configured in one piece with one another. It is thus possible to also support the plastics material layer in the axial direction in the non-composite portion located between the two composite portions by introducing forces into the one-part reinforcement layer.

If at least one composite portion is arranged at an end region of the moulding, this offers the advantage that an improved clamping effect is achieved during the attachment of the moulding to an adjacent component, in particular a tube socket.

If the moulding has at least one flexible zone, at least one non-composite portion is preferably arranged in the flexible zone to increase the flexibility of this flexible zone.

It is particularly favourable if the non-composite portion substantially completely surrounds the flexible zone.

If the moulding has at least one rigid zone, at least one composite portion is preferably arranged in the rigid zone. In this manner, the plastics material layer is particularly well supported in the axial and radial direction in the rigid zone.

It is particularly favourable if a composite portion substantially completely surrounds the rigid zone.

In a preferred configuration of the invention it is provided that, in at least one composite portion, the reinforcing layer is secured in a material-uniting manner relative to the plastics material layer.

This may take place, for example, in that, in at least one composite portion, the reinforcement layer is welded to the plastics material layer by means of a thermoplastic hot-melt adhesive, in particular by means of a thermoplastic fluoroplastics material.

PFA (perfluoroalkoxy copolymer), FEP (perfluoroethylenepropylene copolymer), MFA (tetrafluoroethylene perfluoromethylvinylether) or a thermoplastically processable polytetrafluoroethylene material (PTFE) may be used, for example, as the thermoplastic hot-melt adhesive.

In this case, the thermoplastically processable PTFE material is preferably a TFE copolymer, the co-monomer proportion preferably being 3.5 mol-0% or less, in particular less than 3 mol-0%, more preferably less than 1 mol-0%.

The co-monomer may, in particular, be selected from hexafluoropropylene, perfluoro(alkylvinylether), perfluoro-(2,2-dimethyl-1,3-dioxol) and chlorotrifluoroethylene.

Examples of such suitable thermoplastic PTFE materials are disclosed in WO 00/08071 and WO 01/60911, to which reference is made in this respect.

Furthermore, the thermoplastically processable PTFE material used may be a polymer mixture, which comprises PTFE and a thermoplastically processable plastics material.

Alternatively or in addition to welding of the reinforcement layer and the plastics material by means of a thermoplastic hot-melt adhesive, it may be provided that, in at least one composite portion, the reinforcement layer is vulcanised to the plastics material layer.

As an alternative or in addition to welding or vulcanising the reinforcement layer to the plastics material layer it may furthermore be provided that, on at least one composite portion, the reinforcement layer is adhered by means of an adhesive to the plastics material layer.

As an alternative to this, it may also be provided that at least one composite portion of the moulding is formed by injection moulding, preferably from a fluoroplastics material, the reinforcement layer preferably being connected in the same working operation to the plastics material layer formed by injection moulding.

To increase the compressive strength and the mechanical stability of the moulding according to the invention, it may be provided that the moulding is provided with at least one reinforcement ring.

It is particularly favourable it at least one reinforcement ring is arranged in a non-composite portion of the moulding. Support of the plastics material layer in the non-composite portion in the radial direction is achieved by this.

At least one reinforcement ring may be arranged between the plastics material layer and the reinforcement layer.

As an alternative or in addition to this it may also be provided that at least one reinforcement ring surrounds the reinforcement layer.

In a preferred configuration of the invention it is provided that the moulding is provided with a plurality of reinforcement rings, which are spaced apart from one another in the longitudinal direction of the moulding.

In this case, at least two reinforcement rings can be connected to one another by connecting elements, for example by wires or steel cables, to also achieve axial support by means of the reinforcement rings, in addition to the radial support.

The connecting elements, for example wires or steel cables, may, in particular, be clamped to the reinforcement rings or welded thereto.

In order to also be able to positively connect a reinforcement ring to the plastics material layer after the forming of the plastics material layer of the moulding, it is favourable if at least one reinforcement ring is configured in multiple parts.

In this arrangement, the plurality of parts of the reinforcement ring may, for example, be plugged together and locked to one another.

If the reinforcement layer, in at least one non-composite portion of the moulding, comprises a support material in the form of a woven fabric, hosiery fabric, knitted fabric, tangle fabric, braided fabric or a winding, this support material is preferably provided with a rubber coating to prevent an unravelling of fibres present in a support material of this type.

The tubular moulding according to the invention is suitable, in particular, for use in an assembly, which comprises an exhaust gas turbocharger and an intercooler for an internal combustion engine and a hot-side charge-air line connecting the exhaust gas turbocharger to a charge-air inlet of the intercooler, the hot-side charge-air line comprising a tubular moulding according to the invention.

The tubular moulding according to the invention is easy to produce, handle and assemble and has a high temperature resistance and a high dynamic mechanical resistance, so a tubular moulding of this type is surprisingly also able to withstand the high use temperatures and use pressures in a hot-side charge-air line.

In particular when the plastics material layer of the moulding contains PTFE or modified PTFE, the moulding according to the invention is suitable for low temperatures to −50° C. and for high temperatures up to about 300° C. and can be dynamically highly loaded. The charge-air line formed from a moulding of this type has very good fatigue strength under reversed bending stresses and high acoustic internal damping and a universal chemical resistance to blow-by gases and typical engine media, such as, for example, oils, greases, brake fluid and de-icing salts.

The tubular moulding according to the invention can be produced easily, economically and reliably in terms of the process and is easy to handle during assembly.

The moulding is plastically and/or elastically deformable at its ends so as to connect the moulding directly and in a fluid-tight manner to adjacent units, for example to an exhaust gas turbocharger and an intercooler.

The present invention is based on the further object of providing a method for producing a tubular moulding, by means of which a moulding can be produced with high compressive strength and high mechanical stability with, at the same time, good temperature resistance and good chemical resistance.

This object is achieved according to the invention by a method comprising the following method steps:
arranging a hose, which is formed from a material containing a fluoropolymer material, and a support hose in a blow mould;
heating up the blow mould to a forming temperature;
producing a pressure difference between the interior of the hose and/or the interior of the support hose, on the one hand, and the region of the interior of the blow mould located outside the hose and the support hose, on the other hand, so the hose and the support hose are pressed against the inner wall of the blow mould and together form a moulding with a wall, which comprises a composite of the hose and the support hose;
removing the moulding from the blow mould.

It may be provided here, in particular, that the interior of the hose and/or the support hose is loaded with an increased pressure of, for example, about 6 bar to about 50 bar.

To promote the production of a material-uniting connection between the material of the hose and the material of the support hose, a hose coated with a connecting material and/or a support hose coated with a connecting material may be used.

As an alternative or in addition to this, it may be provided that a connecting material hose is arranged between the hose and the support hose.

Suitable materials for the hose made of plastics material, for the support hose and as a connecting material, have already been mentioned and described above in conjunction with the tubular moulding according to invention.

The higher the forming temperature is selected to be, the lower the memory effect in the formed moulding, i.e. the reforming tendency of the formed moulding during heating.

It is therefore particularly favourable if the forming temperature is above the crystallite melting temperature of the material of the hose.

The object of providing a method for producing a tubular moulding, by means of which a moulding can be produced with good compressive strength and high mechanical stability with simultaneously good temperature resistance and good chemical resistance is also achieved according to invention by a method which comprises the following method steps:
producing a tubular moulding blank made of a material containing a fluoropolymer material;
connecting a support hose to the moulding blank to form a rigid composite in at least one composite portion, wherein the support hose, in at least one non-composite portion, is not connected to the moulding blank to form a rigid composite.

It may be provided, in particular, here that the support hose is welded to the moulding blank, in at least one composite portion, by means of a thermoplastic hot-melt adhesive.

As an alternative or in addition to this, it may be provided that the support hose, in at least one composite portion, is vulcanised to the moulding blank.

As an alternative or in addition to welding or vulcanising the support hose to the moulding blank, it may also be provided that the support hose, in at least one composite portion, is adhered to the moulding blank by means of an adhesive.

The moulding blank may be produced, for example, by blow-moulding.

In a possible configuration of the invention, the support hose is firstly connected to the moulding blank after production of the moulding blank. This offers the advantage that the forming of the moulding blank is not hindered by the support hose.

As an alternative to this, it may also be provided that the support hose is connected to the moulding blank during production of the moulding blank; an additional working operation for connecting the support hose to the moulding blank is thus saved.

Furthermore, it may be provided that the moulding blank is produced at least partially by injection moulding; the support hose can thus be connected in the same working operation to the moulding blank produced by injection moulding.

Further features and advantages of the invention are the subject of the following description and the graphic presentation of embodiments.

### BRIEF DESCRIPTION OF THE DRAWINGS

FIG. 1 shows a schematic block diagram of an internal combustion engine with an exhaust gas turbocharger and an intercooler;

FIG. 2 shows a schematic longitudinal section through a tubular moulding with a plastics material layer and a reinforcement layer, which forms a hot-side charge-air line connecting the exhaust gas turbocharger to a charge-air inlet of the intercooler;

FIG. 3 shows a schematic cross section through the moulding from FIG. 2 along the line 3-3 in FIG. 2;

FIG. 4 shows a schematic longitudinal section through a two-part blow mould and a plastics material hose inserted into the blow mould, and a support hose prior to the blow moulding process, with the blow mould open;

FIG. 5 shows a schematic longitudinal section through the blow mould from FIG. 4 with the plastics material hose inserted and the support hose inserted prior to the blow moulding process, with the blow mould closed;

FIG. 6 shows a schematic longitudinal section through the blow mould from FIGS. 4 and 5 with the formed moulding after completion of the blow moulding process;

FIG. 7 shows a schematic longitudinal section through a second embodiment of a tubular moulding with a plastics material layer and a reinforcement layer, the plastics material layer and the reinforcement layer being connected to one another only in two composite portions in a rigid bond, while the reinforcement layer, in a non-composite portion located between the composite portions, loosely surrounds the plastics material layer;

FIG. 8 shows a schematic longitudinal section through a moulding blank, which is not yet connected to the reinforcement layer;

FIG. 9 shows a schematic longitudinal section through a two-part blow mould and a plastics material hose inserted into the blow mould and inserted reinforcement rings prior to the blow moulding process, with the blow mould open;

FIG. 10 shows a schematic longitudinal section through the blow mould from FIG. 9 with the inserted plastics material hose and the inserted reinforcement rings prior to the blow moulding process, with the blow mould closed;

FIG. 11 shows a schematic longitudinal section through the blow mould from FIGS. 9 and 10 with the formed moulding blank and the reinforcement rings arranged thereon, after completion of the blow moulding process;

FIG. 12 shows a schematic longitudinal section through a third embodiment of a tubular moulding with a plastics material layer and a reinforcement layer, which, in a non-composite portion, loosely surrounds the plastics material layer, a plurality of multi-part reinforcement rings being arranged in the non-composite portion, which rings surround the reinforcement layer from the outside;

FIG. 13 shows a schematic cross section through the non-composite portion of the moulding from FIG. 12 and a multi-part reinforcement ring to be arranged on the non-composite portion, prior to assembly of the reinforcement ring;

FIG. 14 shows a schematic cross section through the non-composite portion of the moulding from FIG. 12 and a multi-part reinforcement ring arranged thereon and surrounding the reinforcement layer from the outside, in the assembled state;

FIG. 15 shows a schematic longitudinal section through a fourth embodiment of a tubular moulding with a plastics material layer and a reinforcement layer, which, in a non-composite portion of the moulding, loosely surrounds the plastics material layer, a plurality of reinforcement rings, which surround the reinforcement layer from the outside and are connected to one another outside the reinforcement layer, being arranged in the non-composite portion;

FIG. 16 shows a schematic longitudinal section through a fifth embodiment of a tubular moulding with a plastics material layer and a reinforcement layer, which, in a non composite portion of the moulding, loosely surrounds the plastics material layer, outer reinforcement rings, which surround the reinforcement layer from the outside and are connected to one another, and inner reinforcement rings, which are provided between the plastics material layer and the reinforcement layer, being arranged in the non-composite portion; and

FIG. 17 shows a schematic longitudinal section through a sixth embodiment of a tubular moulding with a plastics material layer and a reinforcement layer, which, in a non-composite portion of the moulding, loosely surrounds the plastics material layer, no reinforcement rings being provided in the non-composite portion.

The same or functionally equivalent elements are designated by the same reference numerals in all the figures.

### DETAILED DESCRIPTION OF THE INVENTION

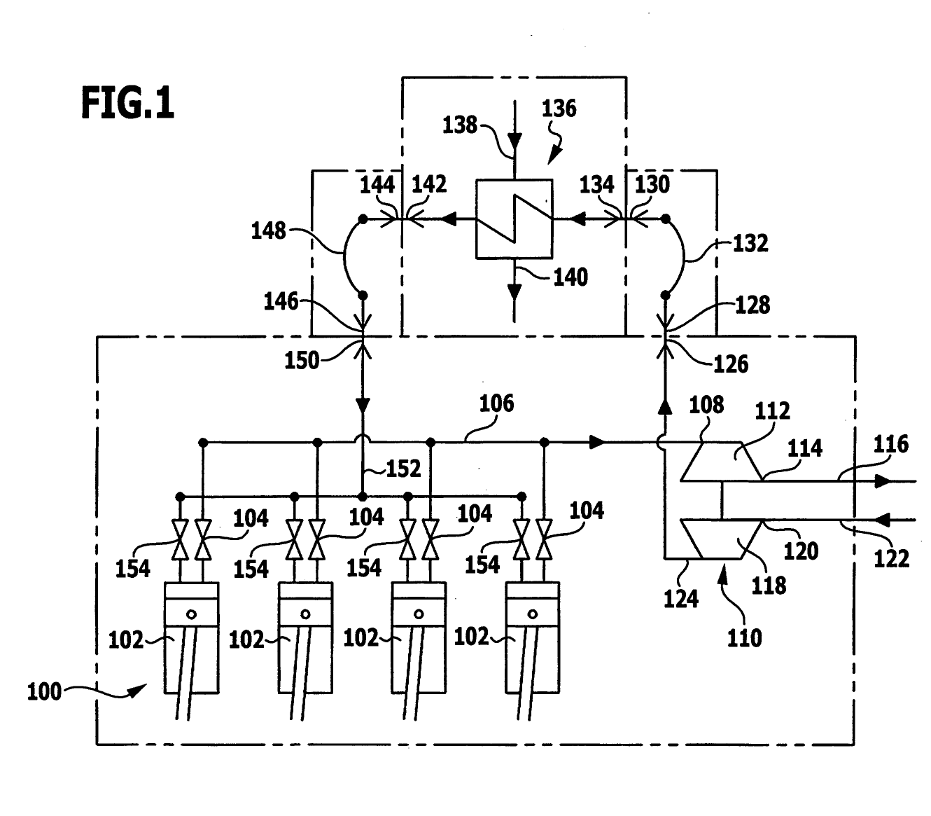

An internal combustion engine designated as a whole by 100 in FIG. 1 comprises a plurality of, for example four, cylinders 102, of which each is connected by an outlet valve 104 to an exhaust gas duct 106, which leads to an exhaust gas inlet 108 of an exhaust gas turbocharger 110. The exhaust gas coming from the internal combustion engine 100 drives an exhaust-gas side thrust wheel 112 in the exhaust gas turbocharger 110 and then leaves the exhaust gas turbocharger 110 via an exhaust gas outlet 114, to which an exhaust gas line 116 is connected.

The exhaust-gas side thrust wheel 112 drives a charge-air side thrust wheel 118, which compresses and accelerates air entering the charge-air side of the exhaust gas turbocharger 110 by an air inlet 120 from an intake air line 122.

The compressed charge-air arrives through an air outlet duct 124 at a charge-air outlet 126 of the exhaust gas turbocharger 110, which is provided with a rapid action coupling connection.

The charge-air outlet 126 is connected to a charge-air inlet 134 of an intercooler 136, provided with a rapid action coupling connection by a hot-side charge-air line 132 provided at the two ends with a rapid action coupling connection 128, 130 in each case.

The charge-air in the hot-side charge-air line 132 has a pressure in the range of about 2.5 bar to about 3 bar, for example, and a temperature in the range of about 200° C. to about 250° C.

The intercooler 136 is a heat exchanger, in which the charge-air is cooled by means of cooling air coming from a radiator of the motor vehicle.

This cooling air enters through a cooling air inlet 138 into the cooling air side of the intercooler 136, absorbs heat from the charge-air and exits again through a cooling air outlet 140 from the intercooler 136.

The charge-air having a pressure of about 1.5 bar, for example, and cooled to a temperature of about 145° C., for example, leaves the charge-air side of the intercooler 136 through a charge-air outlet 142 provided with a rapid action coupling connection, to which charge-air outlet a cold-side charge-air line 148 provided at its two ends with a rapid action coupling connection 144, 146 in each case is connected, which charge-air line connects the intercooler 136 to a charge-air inlet 150 of the internal combustion engine 100, which is also provided with a rapid action coupling connection.

A branching air supply duct 152 leads from the charge-air inlet 150 of the internal combustion engine 100 to inlet valves 154 of the cylinders 102 of the internal combustion engine 100.

The intercooler 136 is connected to the body of the motor vehicle, while the internal combustion engine 100 and the exhaust gas turbocharger 110 arranged thereon are mounted so as to be vibration-decoupled from the body.

The charge-air outlet 126 of the exhaust gas turbocharger 110, on the one hand, and the charge-air outlet 134 of the intercooler 136, on the other hand, therefore move relative to one another during operation of the internal combustion engine 100, which is why the hot-side charge-air line 132 has to have adequate flexibility to be able to compensate the relative movements of its turbocharger-side end and its intercooler-side end.

The exhaust gas turbocharger 110, the intercooler 136 and the hot-side charge-air line 132 connecting the exhaust gas turbocharger 110 to the charge-air inlet 134 of the intercooler 136 therefore form an assembly 156 which is capable of vibrating.

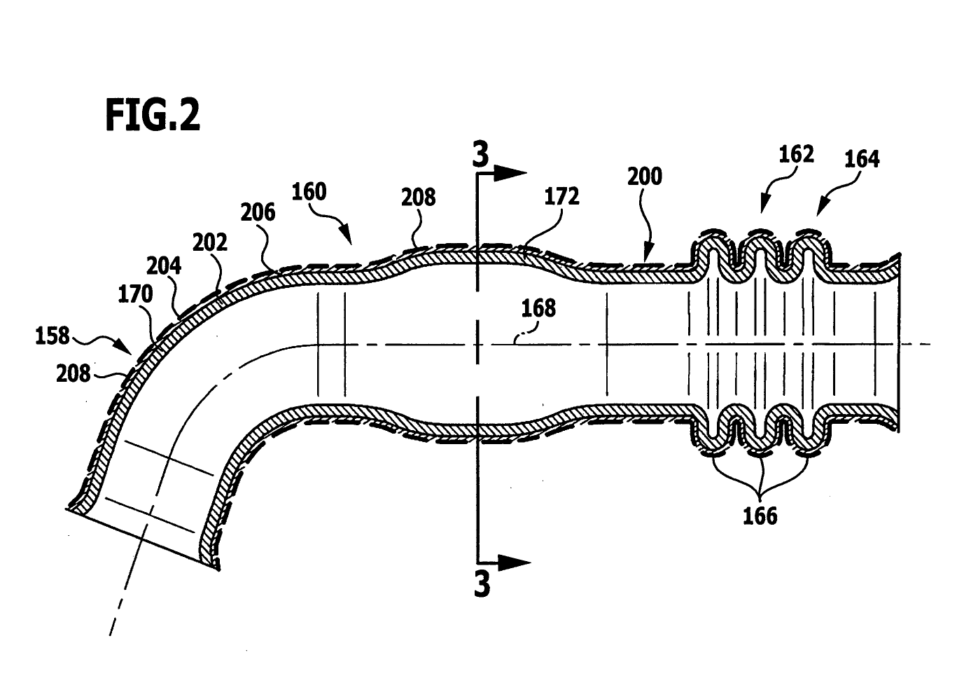

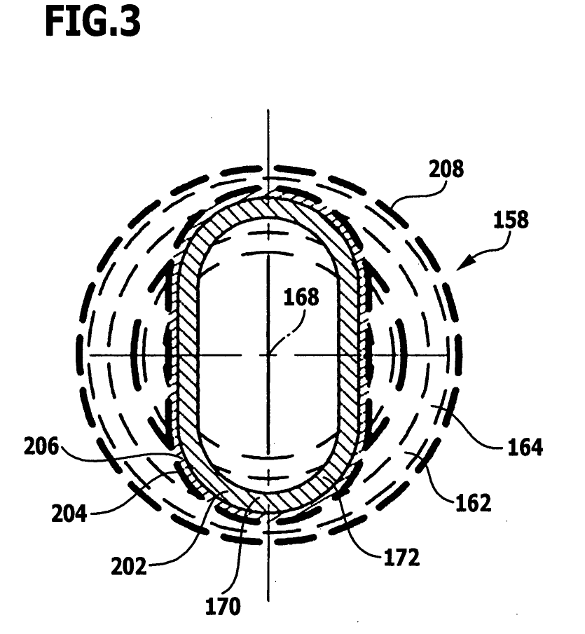

The hot-side charge-air line 132 is formed by a one-piece moulding 158, which is shown in detail in FIGS. 2 and 3.

The tubular moulding 158 has a rigid zone 160 facing the exhaust gas turbocharger 110 and a flexible zone 162 facing the intercooler 136.

The flexible zone 162 comprises a bellows arrangement 164 with a plurality of, for example three, annular folds 166, which allow both an expansion and a compression of the flexible zone 162 along the tube longitudinal axis 168 and also a tilting of the tube longitudinal axis 168 in the region of the flexible zone 162.

The rigid zone 160 of the moulding 158 is substantially dimensionally stable, on the other hand.

The rigid zone 160 may have a curved portion 170,

Furthermore, the rigid zone 160 may have a portion 172 with an oval cross section (see FIG. 3) arranged, for example, between the curved portion 170 and the flexible zone 162.

Outside the portion 172 with the oval cross section and the curved portion 170, the tubular moulding 158 is configured substantially rotationally symmetrically with respect to the tube longitudinal axis 168.

The moulding 158 has a wall 200, which is formed as a composite of an inner plastics material layer 202, an outer reinforcement layer 204 and a connecting layer 206 located in between and connecting the reinforcement layer 204 to the plastics material layer 202.

The plastics material layer 202 is formed in one piece from a PTFE, modified PTFE, PFA (perfluoroalkoxy copolymer) or another partially or fully fluorinated plastics material in pure form or in a mixture with material containing fillers, which in the operating pressures prevailing in the hot-side charge-air line 132 of about 2.5 bar to about 3 bar, for example, is mechanically stable and in the operating temperatures prevailing in the hot-side charge-air line 132 of about 200° C. to about 250° C. is thermally stable.

The plastics material layer 202 is preferably formed from a PTFE compound or a modified PTFE compound.

This PTFE compound or modified PTFE compound may contain a black pigment, preferably carbon black, in a quantity of up to 10 percent by weight to dye the plastics material layer 202 black.

The reinforcement layer 204, which is used to increase the compressive strength and the mechanical stability of the moulding 158, may be configured as a woven fabric, hosiery fabric, knitted fabric, tangle fabric or braided fabric made of fibres, which withstand the temperatures in the production of the moulding 158 and during operation of the hot-side charge-air line 132.

For this purpose, glass fibres, carbon fibres, aramid fibres or fibres made of a thermoplastic plastics material with a high melting point are possibilities, in particular.

The reinforcement layer 204 may be configured, in particular, as a woven, hosiery, knitted or wound support hose 208 made of one of the materials mentioned above.

The connecting layer 206 between the plastics material layer 202 and the reinforcement layer 204, which connects the plastics material layer 202 and the reinforcement layer 204 to form a composite material, may be formed from a thermoplastic plastics materials, in particular from a fluorothermoplastics material, such as, for example, PFA (perfluoroalkoxy copolymer), FEP (perfluoroethylenepropylene copolymer), MFA (tetrafluoroethylene perfluoromethylvinylether) or modified PTFE.

As an alternative to this, the connecting layer 206 may also be formed from a traditional adhesive system, which is applied retrospectively.

The tubular moulding 158 is provided at its two ends with a rapid action coupling connection (not shown) in each case.

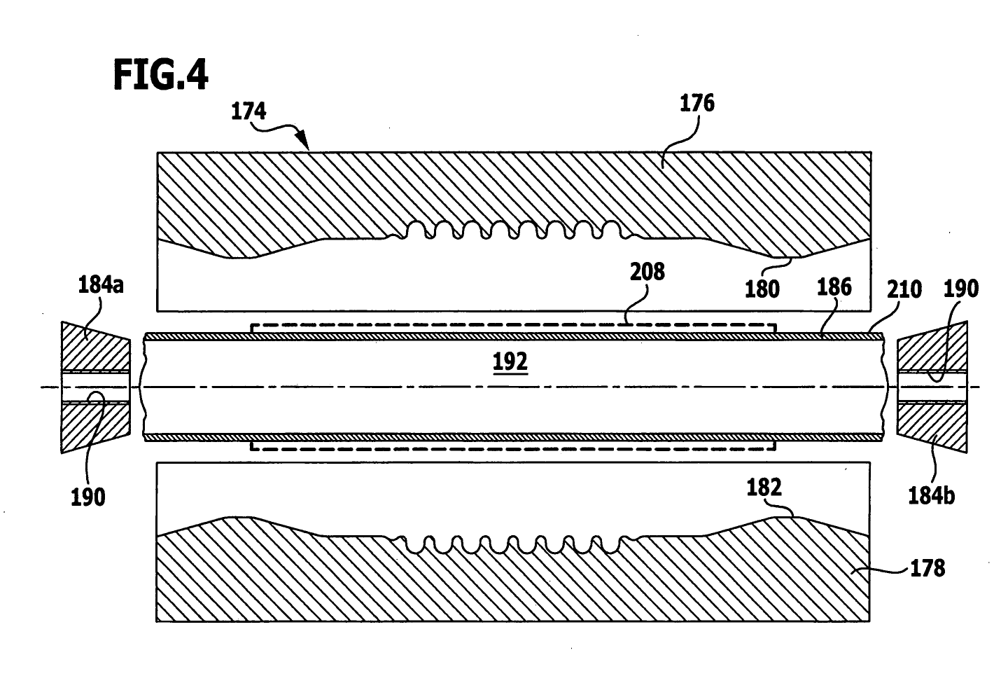

The tubular moulding 158 is preferably produced by a blow moulding process, which is described below with reference to FIG. 4 to 6.

A multi-part blow mould 174 is used for the blow moulding process and comprises an upper part 176 and a lower part 178, the insides 180, 182 of which, facing one another, being configured according to the desired outer contour of the moulding 158, and two end-face connection pieces 184a, 184b.

With an opened blow mould 174 (see FIG. 4) a hose 186 made of the PTFE, modified PTFE, PFA or another partially or fully fluorinated thermoplastics material in pure form or with a starting material containing fillers for the plastics material layer 202 is inserted between the upper part 176 and the lower part 178 of the blow mould 174.

The outside 210 of the hose 186 is coated with a hot-melt adhesive made of a fluorothermoplastics material, such as, for example, PFA, FEP, MFA or modified PTFE.

The support hose 208 made of the material forming the reinforcement layer 204 is pulled over the hose 186 made of the starting material for the plastics material layer 202.

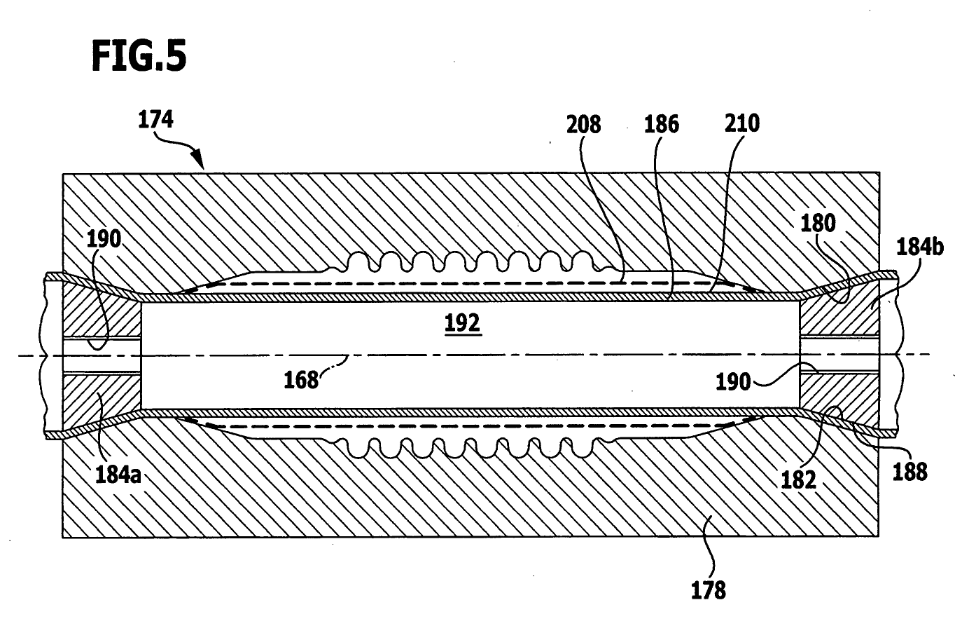

The blow mould 174 is then closed (see FIG. 5), the two ends of the hose 186 being pulled, in each case, over a connection piece 184a, 184b and, clamped between the outside 188 of a connection piece 184a, 184b, on the one hand, and the inside 180 or 182 of the upper part 176 or the lower part 178 of the blow mould 174, on the other hand.

The blow mould 174 is then heated by means of a heating device (not shown) to a blowing temperature in the range of about 250° C. to about 400° C.

The higher the blowing temperature is selected to be, the lower the memory effect in the formed moulding 158, i.e. the reforming tendency of the plastics material layer 202 of the moulding 158 on heating.

It is particularly favourable if the blow-moulding is carried out at a temperature above the crystallite melting temperature of the starting material of the hose 186.

In the case of pure PTFE as the starting material for the plastics material layer 202, the crystallite melt temperature is about 327° C.

After reaching the desired blowing temperature, air or an inert gas is supplied at a blowing pressure of, for example, about 6 bar to about 50 bar through feed ducts 190 in the connection pieces 184a, 184b to the interior 192 of the hose 186.

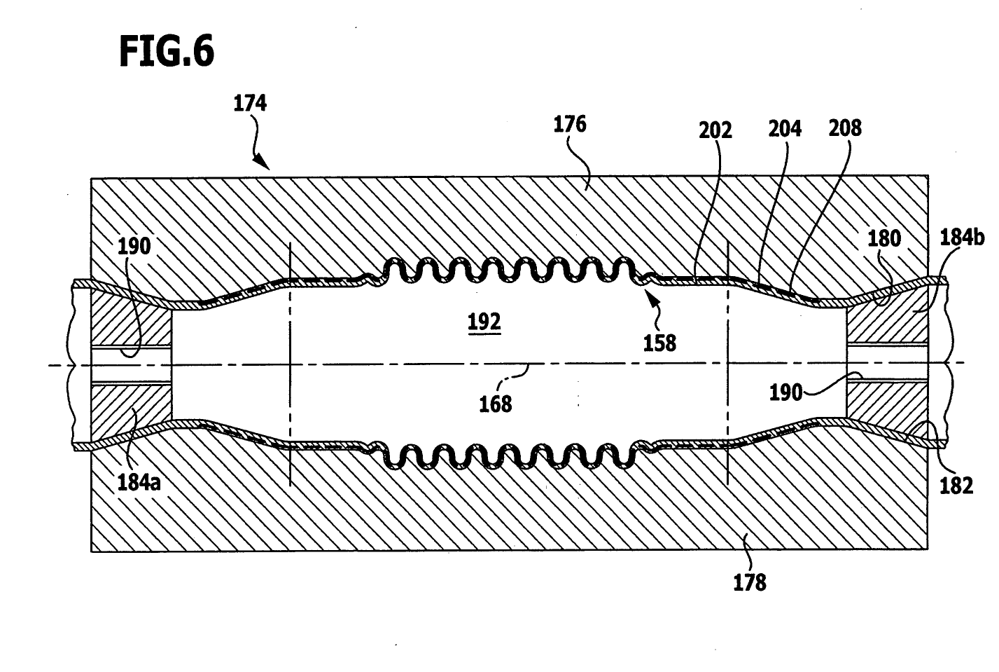

The wall of the hose 186 is inflated by this loading of its interior 192 with the increased blowing pressure and rests on the insides 180, 182 of the upper part 176 or the lower part 178 of the blow mould 174 (see FIG. 6), the support hose 208 located in between being pressed against the upper part 176 or the lower part 178 of the blow mould and also against the outside 210 of the hose 186, so the desired contour of the moulding 158 is formed.

At the increased blowing temperature, the hot-melt adhesive coating of the hose 186 connects to the material of the plastics material layer 202 formed from the hose 186 and also to the material of the reinforcement layer 204 formed from the support hose 208, so the connecting layer 206 which connects the plastics material layer 202 and the reinforcement layer 204 to form a non-detachable composite, is formed from the hot-melt adhesive coating.

The increased blowing pressure in the interior 192 of the hose 186 or the formed moulding 158 is maintained during a blowing period in the region of a few seconds to a few minutes.

The blow mould 174 is then cooled by switching off the heating device and optionally by additional cooling to a temperature for removal from the mould in the region of about 100° C. to about 250° C.

After reaching the desired temperature for removal from the mould, the multi-part blow mould 174 is opened and the formed tubular moulding 158 is removed.

After the configuration of the rapid action coupling connections at the ends of the moulding 158, the tubular moulding 158 can be used as a hot-side charge-air line 132 in the assembly 156.

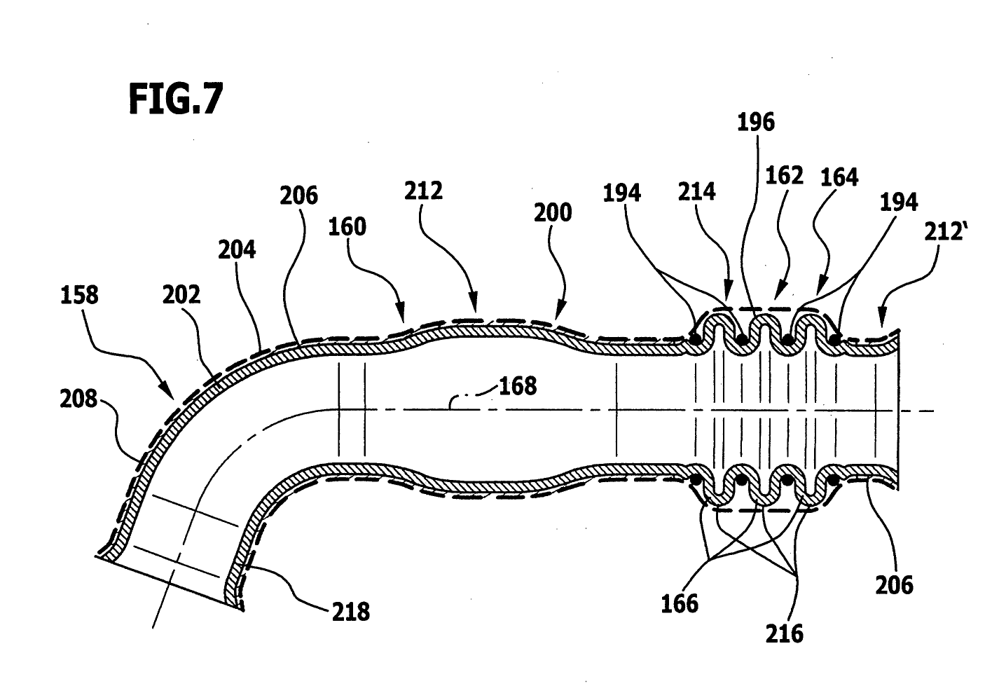

A second embodiment shown in FIG. 7 of a tubular moulding 158 differs from the first embodiment shown in FIGS. 2 and 3 in that the reinforcement layer 204 is not connected over the entire length of the moulding 158 in a rigid bond with the plastics material layer 202 but merely in two composite portions 212 and 212′ spaced apart from one another along the tube longitudinal axis 168, the first composite portion 212 comprising the rigid zone 160 of the moulding 158 and the second connecting portion 212′ comprising an end portion of the moulding 158, which is arranged on the side of the bellows arrangement 164 remote from the rigid zone 160.

A non-composite portion 214 of the moulding 158, in which the reinforcement layer 204 and the plastics material layer 202 are not connected in a rigid bond with one another, but rather the reinforcement layer 204 loosely surrounds the plastics material layer 202, extends between the ends of the two composite portions 212, 212′ facing one another.

As can be seen from FIG. 7, in the non-composite portion 214, the reinforcement layer 204 only rests on the outer crests 216 of the folds 166 of the bellows arrangement 164, but does not extend in the valleys located between the crests 216.

In this embodiment, the reinforcement layer 204 thus does not rest flatly everywhere on the plastics material layer 202.

Furthermore, the reinforcement layer 204 in the non-composite portion 214 is moveable relative to the plastics material layer 202 both in the axial direction and in the peripheral direction of the moulding 158 (to a certain extent).

To increase the compressive strength and the mechanical stability, the moulding 158 in this embodiment is furthermore provided with a plurality of, for example four, reinforcement rings 194, which are arranged radially inside the reinforcement layer 204 and, from the outside, in particular in the region between two respective folds 166, rest on the outside 196 of the plastics material layer 202.

These reinforcement rings 194 may be formed from a metallic material, for example of a steel material, or of thermally and mechanically adequately resistant plastics material, for example PEEK or PPS.

As an alternative, or in addition to this, it may also be provided that at least one reinforcement ring 194 configured as a textile reinforcement ring, which is formed from a fibre material.

This fibre material may comprise organic, mineral and/or metallic fibres.

The at least one reinforcement ring 194 may be braided, woven and/or spun from a fibre material of this type.

The reinforcement rings 194 may be single-part or multi-part.

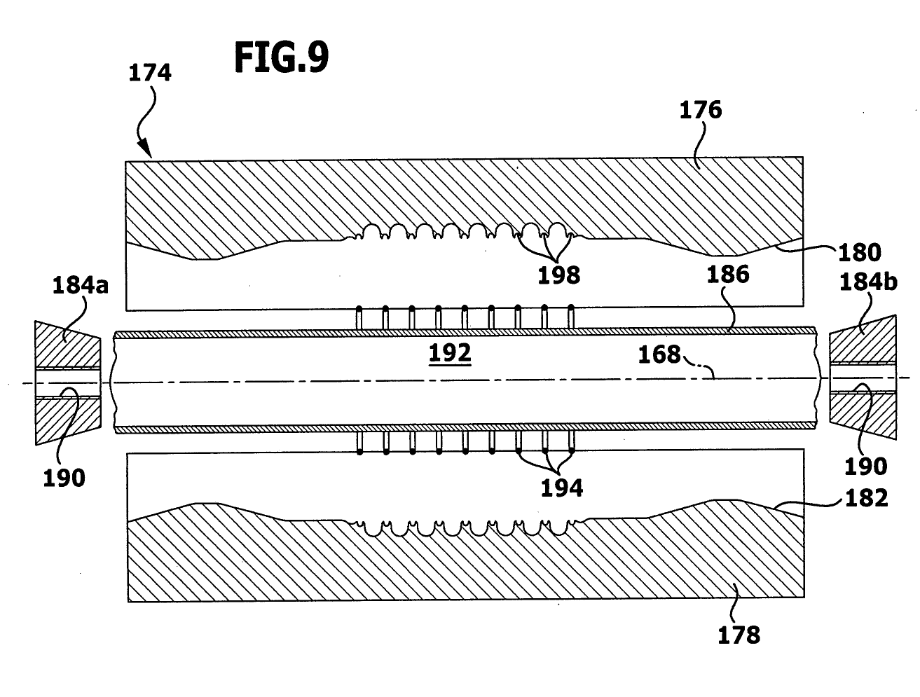

Single-part reinforcement rings 194 may already be connected to the plastics material layer 202 when it is formed, as shown in FIG. 9 to 11.

As can be seen from FIG. 9, for this purpose, when the multi-part blow mould 174 is open, the reinforcement rings 194 together with the hose 186 made of the starting material are inserted at the desired axial position between the upper part 176 and the lower part 178 of the blow mould 174, the hose 186 made of the starting material extending through the reinforcement rings 194.

Unlike the blow moulding process shown in FIG. 4 to 6, however, no support hose made of the material forming the reinforcement layer 204 is pulled in this case over the hose 186 made of the starting material for the plastics material layer 202.

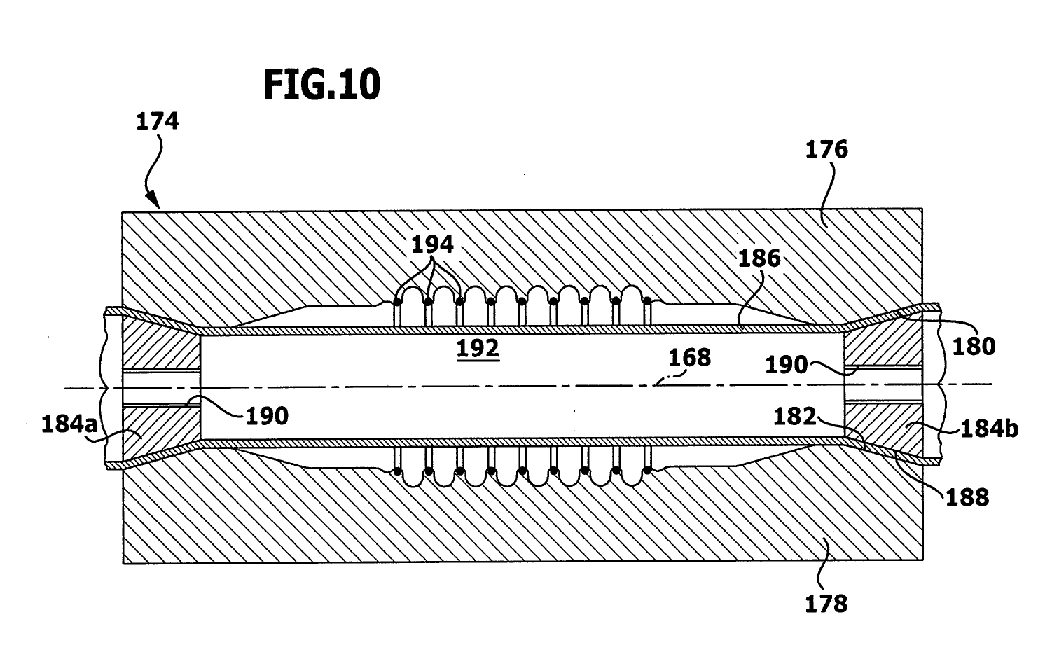

The blow mould 174 is then closed (see FIG. 10), the reinforcement rings 194 being received in annular grooves 198 provided for this purpose on the insides 180, 182 of the upper part 176 or the lower part 178 of the blow mould 174, so the reinforcement rings 194 retain their desired orientation relative to the tube longitudinal axis 168 during the blow moulding process and do not tilt.

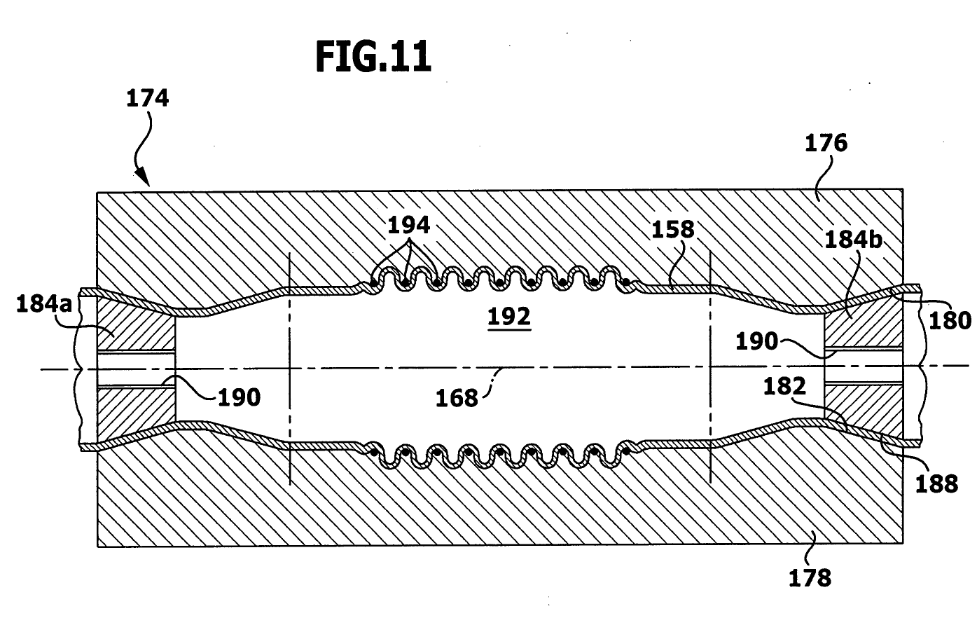

After the closing of the blow mould 174 and heating it up to the blowing temperature, the blow moulding process is carried out as in the first embodiment shown in FIG. 4 to 6 by loading the interior 192 of the hose 186 with air or inert gas at the blowing pressure, so that the hose 186 made of the starting material is moulded into a moulding blank 218 with the desired contour of the plastics material layer 202 (see FIG. 11),

The reinforcement rings 194 are now positively connected to the moulding blank 218, so the moulding blank 218 with the reinforcement rings 194 can be handled as a unit and assembled.

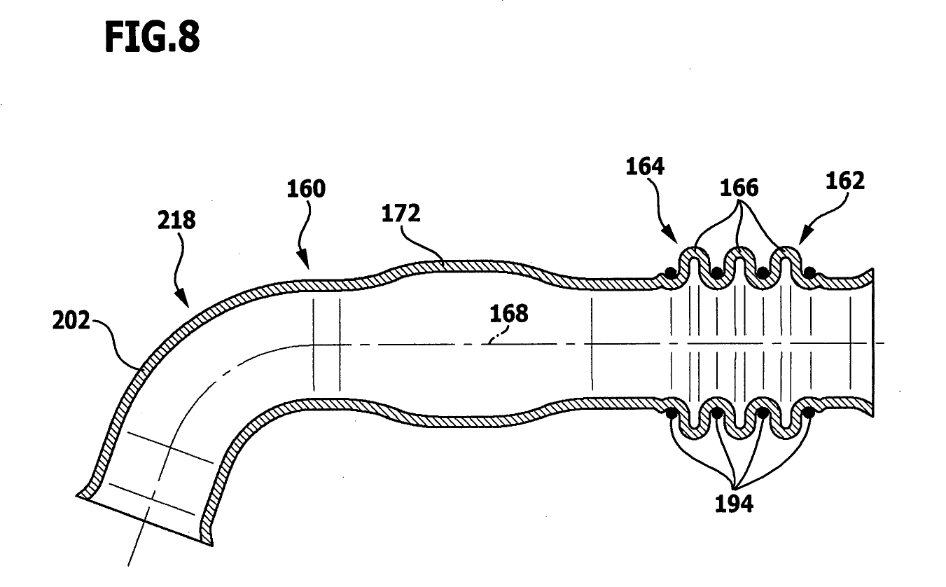

After cooling the blow mould 174 to the temperature for removal from the mould, the blow mould 174 is opened and the moulding blank 218 with the reinforcement rings 194 arranged therein is removed (see FIG. 8).

In a second working operation, a support hose 208 made of the material forming the reinforcement layer 204 is pulled over the moulding blank 218 shown in FIG. 8 with the reinforcement rings 194 already arranged thereon and rigidly welded to the moulding blank 218 in the composite portions 212 and 212′ with the formation of a connecting layer 206, so a rigid composite of the reinforcement layer 204 (formed from the material of the support hose 208) and the plastics material layer 202 (formed from the material of the moulding blank 218) is produced in the composite portions 212 and 212′, wherein the reinforcement layer 204 and the plastics material layer 202 are rigidly connected to one another by the connecting layer 206 arranged in between.

In the non-composite portion 214 located between the composite portions 212 and 212′, however, the support hose 208 is not secured to the moulding blank 218, so, in this portion, the reinforcement layer 204 formed from the support hose 208 only rests loosely over the folds 166 of the bellows arrangement 164.

The support hose 208 can be welded to the moulding blank 218 in the composite portions 212, 212′ in particular by welding by means of a thermoplastic hot-melt adhesive.

A thermoplastic fluoroplastics material, for example PFA (perfluoroalkoxy copolymer), FEP (perfluoroethylenepropylene copolymer), MFA (tetrafluoroethylene perfluoromethylvinylether) or thermoplastically processable PTFE can be used, in particular, as a thermoplastic hot-melt adhesive of this type.

To introduce the hot-melt adhesive between the support hose 208 and the moulding blank 218, there are the following possibilities, in particular:

a) the material of the support hose 208, in particular a fibre glass woven fabric, can be saturated with an emulsion or a dispersion, which contains a thermoplastic fluoroplastics material, and then dried.
b) a film made of the thermoplastic fluoroplastics material may be inserted between the support hose 208 and the moulding blank 218.
c) a moulding (for example a rotated one) made of the thermoplastic fluoroplastics material may be inserted between the support hose 208 and the moulding blank 218.
d) fibres made of thermoplastic fluoroplastics material may be introduced, for example woven, into the material of the support hose 208.
e) the thermoplastic fluoroplastics material may be sprayed on, liquid fluoroplastics material under pressure being pressed between and through the layers of the support hose 208.

Furthermore, the thermoplastic hot-melt adhesive can also be introduced by a combination of a plurality of the above-described methods a) to e) into the intermediate space between the support hose 208 and the moulding blank 218.

The temperature of the thermoplastic hot-melt adhesive is then increased to a welding temperature which is above the melting temperature of the hot-melt adhesive, so the hot-melt adhesive connects both to the material of the plastics material layer 202 formed from the moulding blank 218 and to the material of the reinforcement layer 204 formed from the support hose 208, so the connecting layer 206, which connects the plastics material layer 202 and the reinforcement layer 204 to form a non-detachable bond, is formed from the hot-melt adhesive.

The welding temperature is preferably above the gel temperature of the material of the moulding blank 218, in other words, for example, above 327° C. (gel temperature of polytetrafluoroethylene).

It is particularly favourable if excess hot-melt adhesive penetrates through the support hose 208 and forms a smooth protective layer on the outside of the support hose 208. The fibres of the support hose material are protected from damage from the outside of the moulding 158 by an outer support layer of this type.

To achieve a protective effect of this type, the support hose 208, in particular in the non-composite portion 214, can be rubber-coated, and this also offers protection against unravelling of the fibres of the support hose material.

As an alternative or in addition to the welding described above of the support hose 208 and of the moulding blank 218 by means of a thermoplastic hot-melt adhesive, it may also be provided that the support hose 208 is vulcanised by means of a temperature-resistant elastomer, preferably a fluoroelastomer, to the moulding blank 218.

For this purpose, the (for example PTFE-containing) surface of the moulding blank 218 is chemically activated by wet etching prior to the vulcanisation and optionally provided with a primer to improve the adhesion of the elastomer layer to be subsequently produced.

After the chemical activation of the surface of the moulding blank 218, an elastomer layer is introduced between the support hose 218 and the moulding blank 218, for example by a spray method or by a laminating method (similarly to the methods a) to c) described above for introducing the thermoplastic hot-melt adhesive during the welding method).

As an alternative or in addition to the welding or vulcanisation of the support hose 208 to the moulding blank 218, it may also be provided that the support hose 208 is adhered to the moulding blank 218 by means of a temperature-resistant adhesive. Before a bonding of this type, the surface of the moulding blank 218 is etched and if necessary provided with a primer.

As an alternative or in addition to the above-described methods, the support hose 208 may also be rigidly connected to the moulding blank 218 by form- and/or force-locking, for example by mechanical clamping by means of known clamping devices.

Instead of firstly producing a moulding blank 218 by blow moulding and then connecting it to the support hose 208, it may also be provided that the plastics material layer 202 of the moulding 158 is produced by injection moulding from a starting material containing a fluoroplastics material, the support hose 208 being embedded in the plastics material in the same working operation.

It may also be provided that only the flexible zone 162 of the moulding 158 with the bellows arrangement 164 is produced by blow moulding and corresponding smooth tube regions are joined to this moulding blank on either side of the composite portions 212, 212′ by thermoplastic spraying on of other fluoroplastics materials, for example thermoplastically processable PTFE, the reinforcement layer 204 from the support hose 208 being embedded in the plastics material layer 202 simultaneously with the thermoplastic spraying on in the same working operation.

The tubular moulding 158 shown in FIG. 7 and produced in one of the manners described above offers the advantage that the plastics material layer 202 is supported in the composite portions 212 and 212′ (smooth tube regions) both in the radial direction and in the axial direction by the rigid bond with the reinforcement layer 204.

In the non-composite portion 214 (fold region), the plastics material layer 202 is supported in the radial direction by the reinforcement rings 194 and in the axial direction by the reinforcement layer 204, which forms a rigid bond with the plastics material layer 202 in the composite portions 212, 212′ directly adjoining the non-composite portion 214 and spans the non-composite portion 214 in one piece, so axial forces acting on the plastics material layer 202 in the non-composite portion 214 can be absorbed by the reinforcement layer 204.

Moreover, an improvement in the clamping effect of clamping connections which engage on the ends of the moulding 158, is achieved by the rigid bond of the reinforcement layer 204 and the plastics material layer 202 in the composite portions 212 and 212′, which form end regions of the tubular moulding 158.

Otherwise, the second embodiment of a tubular moulding 158 shown in FIG. 7 to 11 coincides with respect to structure, function and mode of production with the first embodiment shown in FIG. 1 to 6, the above description of which is referred to in this regard.

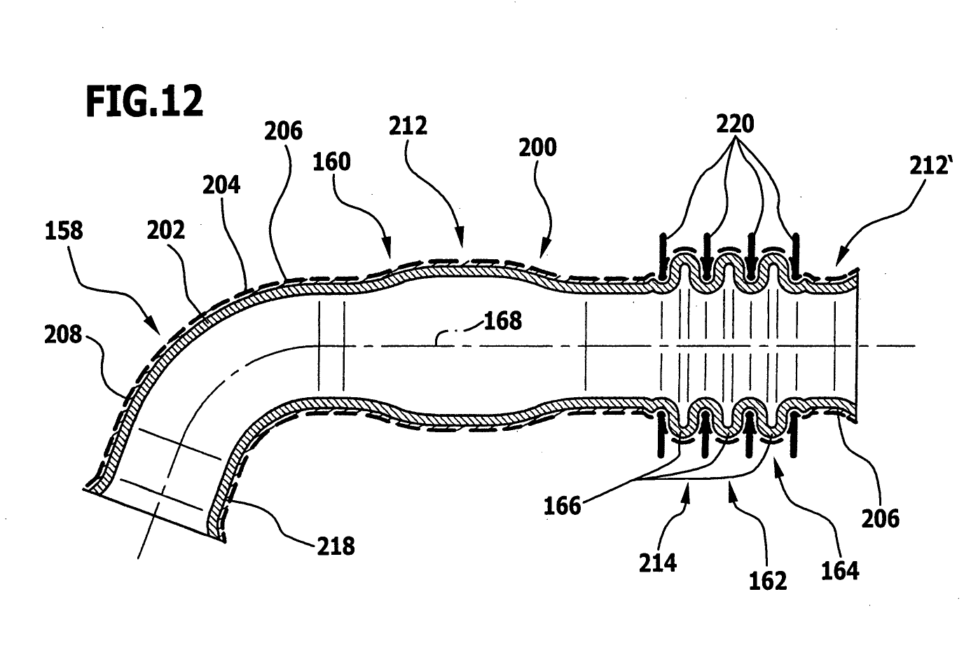

A third embodiment of a tubular moulding 158 shown in FIG. 12 to 14 differs from the second embodiment shown in FIG. 7 in that, instead of the inner reinforcement rings 194, which are arranged between the plastics material layer 202 and the reinforcement layer 204, outer reinforcement ring 220 are provided in the region of the bellows arrangement 164 and are arranged radially outside the reinforcement layer 204 and annularly surround the reinforcement layer 204.

Such outer reinforcement rings 220 cannot already be arranged during the blow moulding process on the moulding blank 218, but have to have a multi-part configuration so as to be able to be arranged, after the support hose 208 has been pulled onto the moulding blank 218, on the outside of the support hose 208.

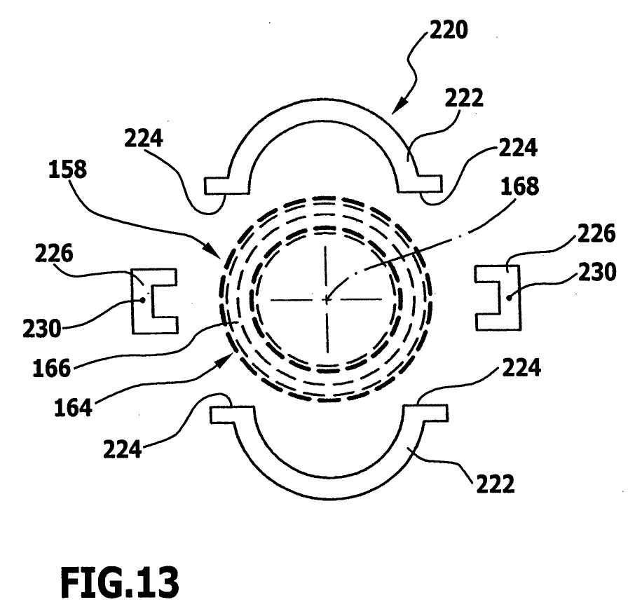

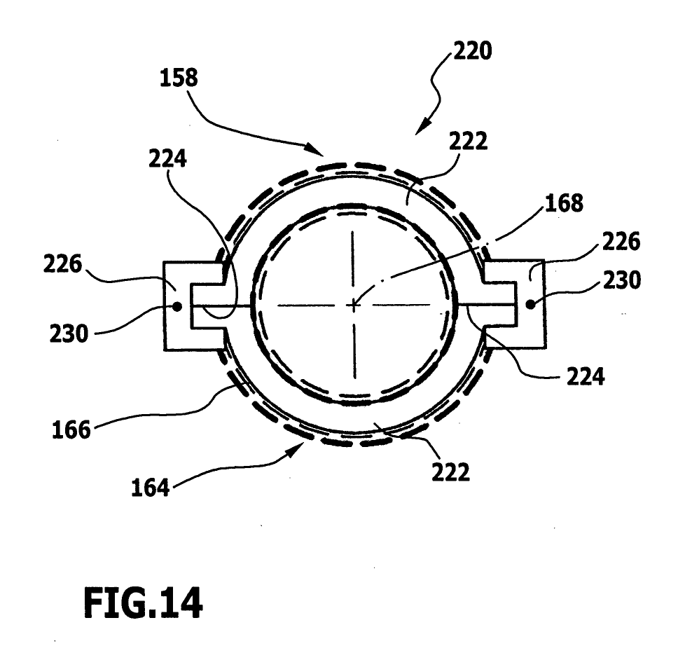

As can be seen from FIGS. 13 and 14, a multi-part outer reinforcement ring 220 of this type comprises two semicircular arc-shaped ring parts 222, which rest on one another in the assembled state of the reinforcement ring 220 (see FIG. 14) with contact faces 224, as well as two substantially U-shaped clamping parts 226 which, when the reinforcement ring 220 is in the assembled state, brace the contact regions of the ring parts 222 against one another with the contact faces 224.

To prevent an undesired release of the clamping parts 226 from the ring parts 222, the ring parts 222 and the clamping parts 226 are provided with locking elements (not shown) which cooperate with one another and which secure the clamping parts 226 against being displaced in the radial direction relative to the ring parts 222 when the reinforcement ring 220 is in the assembled state.

As can be seen from FIG. 12, the outer reinforcement rings 220, as well as the inner reinforcement rings 194 of the second embodiment, are arranged in particular in the region between two respective folds 166 of the bellows arrangement 164 on the outside of the reinforcement layer 204.

Owing to the arrangement of the outer reinforcement rings 220 on the outside of the reinforcement layer 204, the reinforcement layer 204 in this embodiment is deformed in the non-composite portion 214 in such a way that it also extends into the valleys between the folds 166 of the bellows arrangement 164; as in the second embodiment of the moulding 158 shown in FIG. 7, the reinforcement layer 204 is, however, in this embodiment, also not connected in a rigid bond to the plastics material layer in the non-composite portion 214.

The outer reinforcement rings 220 of the third embodiment may basically be produced from the same material as the reinforcement rings 194 of the second embodiment.

Otherwise, the third embodiment of a tubular moulding 158 shown in FIG. 12 coincides with respect to structure, function and mode of production with the second embodiment shown in FIG. 7 to 11, to the above description of which reference is made in this regard.

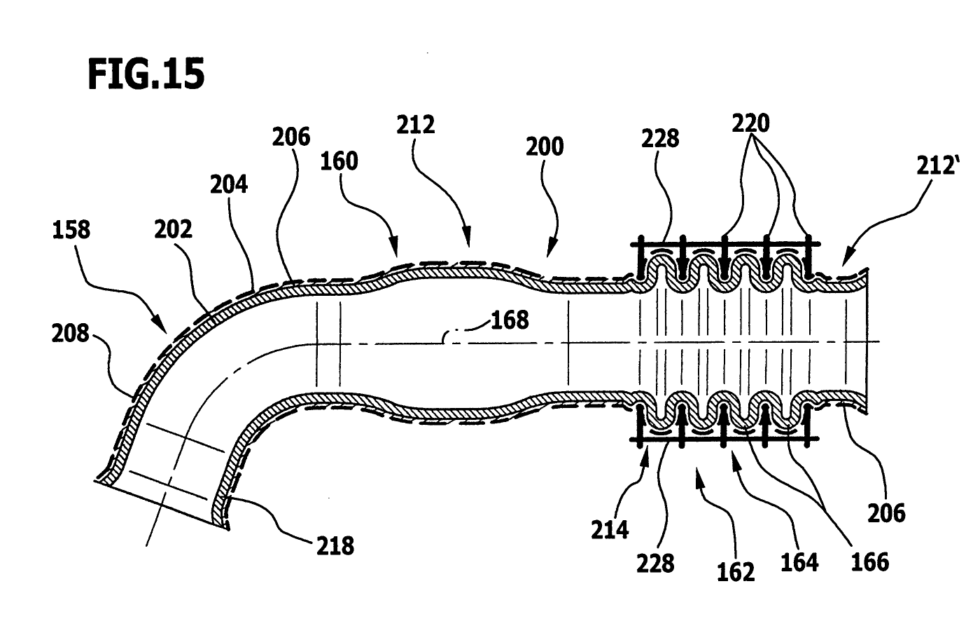

A fourth embodiment shown in FIG. 15 of a tubular moulding 158 differs from the third embodiment shown in FIG. 14 in that the outer reinforcement rings 220 which are spaced apart from one another in the direction of the tube longitudinal axis 168 are connected to one another by means of connecting elements 228, for example cables or wires.

Connecting elements 228 of this type increase the mechanical stability of the moulding 158 in the flexible zone 162.

The outer reinforcement rings 220 may not only be connected to one another by means of such connecting elements 228, but also to an external connection of the tubular moulding 158, engaging on the end regions of the moulding 158.

The connecting elements 228, may extend, in particular through through-openings 230 on the clamping parts 226 of the outer reinforcement rings (see FIGS. 13 and 14) and be welded and/or clamped to these clamping parts 226.

Otherwise, the fourth embodiment of a tubular moulding 158 shown in FIG. 15 coincides in terms of structure, function and mode of production with the third embodiment shown in FIG. 14, to the above description of which reference is made in this regard.

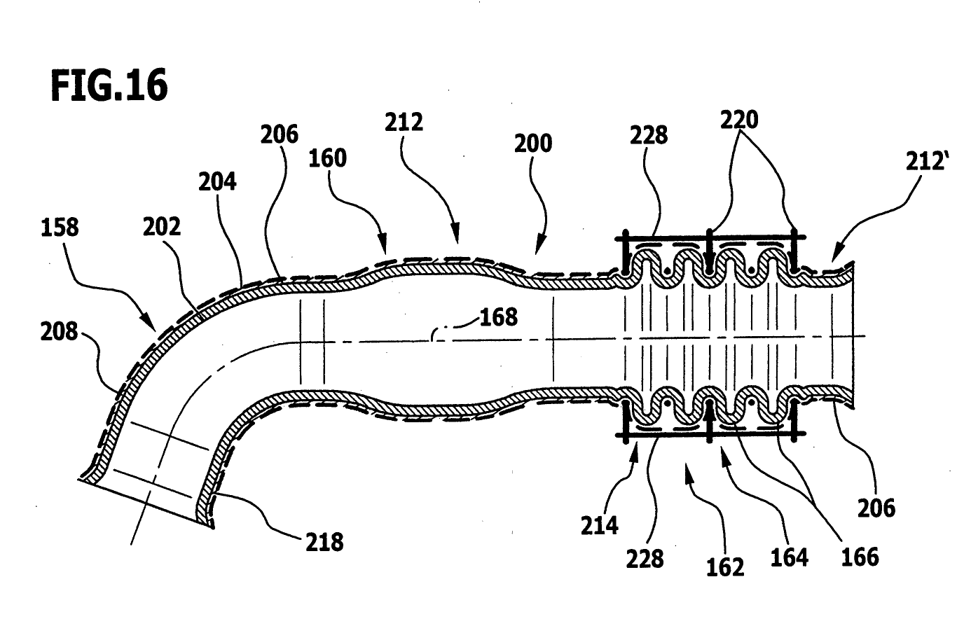

A fifth embodiment of a tubular moulding 158 shown in FIG. 16 differs from the fourth embodiment shown in FIG. 15 in that each second outer reinforcement ring 220 is replaced by an inner reinforcement ring 194, so respective outer reinforcement rings 220, which are arranged outside the reinforcement layer 204, and inner reinforcement rings 194, which are arranged between the reinforcement layer 204 and the plastics material layer 202, follow one another alternately in the region of the bellows arrangement 164 along the tube longitudinal axis 168.

The outer reinforcement rings 220 are connected to one another by connecting elements 228 in the axial direction.

The inner reinforcement rings 194 are already arranged during production of the moulding blank 218 by a blow moulding process on the moulding blank 218, as has been described above in conjunction with the second embodiment of the moulding 158.

Otherwise, the fifth embodiment of a tubular moulding 158 shown in FIG. 16 coincides with respect to structure, function and mode of production with the fourth embodiment shown in FIG. 15, to the above description of which reference is made in this regard.

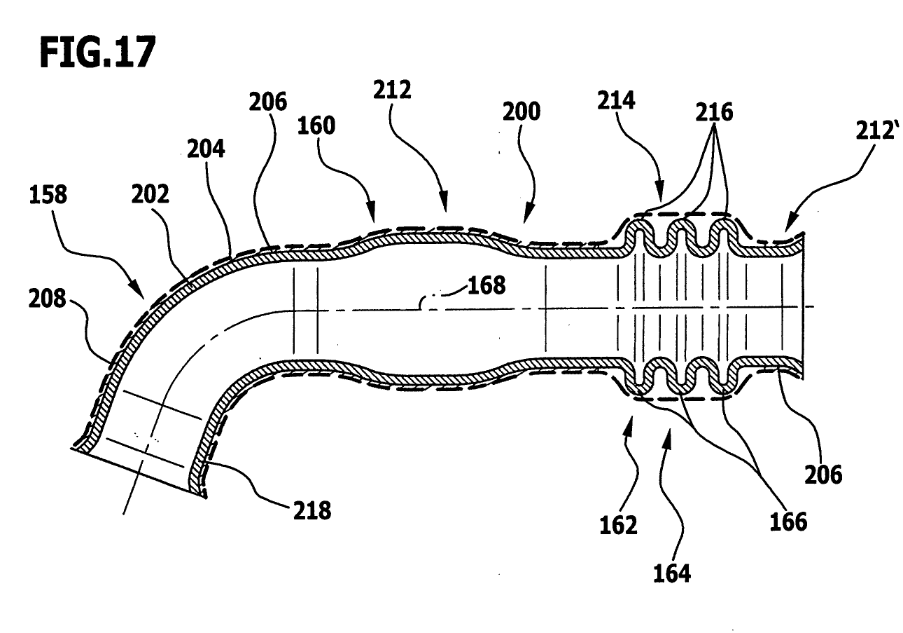

A sixth embodiment of a tubular moulding 158 shown in FIG. 17 differs from the second embodiment shown in FIG. 7 in that neither inner reinforcement rings 194 nor outer reinforcement rings 220 are provided in the flexible zone 162 of the moulding 158.

In this case, no reinforcement rings 194 are inserted in the blow mould 174 during production of the moulding blank 218.

Otherwise, the sixth embodiment of a tubular moulding 158 shown in FIG. 17 coincides with regard to structure, function and mode of production with the second embodiment shown in FIG. 7 to 11, to the above description of which reference is made in this regard.

1. Tubular moulding with a wall, wherein the wall comprises a composite, which comprises a plastics material layer, which is formed from a material containing a fluoropolymer material, and a reinforcement layer.

2. Moulding according to claim 1, wherein the reinforcement layer at least partially surrounds the plastics material layer.

3. Moulding according to claim 1, wherein the plastics material layer is configured so as to be self-supporting.

4. Moulding according to claim 1, wherein the reinforcement layer is configured so as to be self-supporting.

5. Moulding according to claim 1, wherein the reinforcement layer comprises a support hose.

6. Moulding according to claim 1, wherein the reinforcement layer comprises a woven fabric, hosiery fabric, knitted fabric, tangle fabric or braided fabric or a winding.

7. Moulding according to claim 1, wherein the reinforcement layer contains a fibre glass material, a carbon fibre material, an aramid fibre material and/or a fibre material made of a thermoplastic plastics material.

8. Moulding according to claim 1, wherein a connecting layer is arranged between the plastics material layer and the reinforcement layer.

9. Moulding according to claim 8, wherein the connecting layer contains a thermoplastic plastics material.

10. Moulding according to claim 8, wherein the connecting layer contains a fluorothermoplastics material, in particular PFA, FEP, MFA or modified PTFE.

11. Moulding according to claim 1, wherein the moulding has at least one flexible zone.

12. Moulding according to claim 11, wherein the flexible zone comprises a bellows arrangement.

13. Moulding according to claim 1, wherein the moulding comprises at least one rigid zone.

14. Moulding according to claim 13, wherein the rigid zone has at least one curved portion.

15. Moulding according to claim 1, wherein the moulding is blow-moulded.

16. Moulding according to claim 1, wherein the moulding is moulded at a temperature above the crystallite melting temperature of the starting material of the plastics material layer.

17. Moulding according to claim 1, wherein the plastics material layer is formed from a PTFE compound and/or a modified polytetrafluoroethylene compound.

18. Moulding according to claim 17, wherein the PTFE compound or the modified polytetrafluoroethylene compound contains a black pigment, preferably carbon black.

19. Moulding according to claim 1, wherein the moulding is thermally stable at an operating temperature of at least 200° C., preferably at least 250° C.

20. Moulding according to claim 1, wherein the moulding is mechanically stable at an internal operating pressure of at least 2 bar, preferably of at least 2.5 bar.

21. Moulding according to claim 1, wherein the moulding has at least one composite portion, in which the reinforcement layer and the plastics material layer are connected to one another with a rigid bond, and at least one non-composite portion, in which the reinforcement layer and the plastics material layer are not connected to one another with a rigid bond.

22. Moulding according to claim 21, wherein in at least one non-composite portion, the reinforcement layer loosely surrounds the plastic material layer.

23. Moulding according to claim 21, wherein the moulding has at least two composite portions, between which a non-composite portion is arranged.

24. Moulding according to claim 23, wherein the reinforcement layer of a first composite portion and the reinforcement layer of a second composite portion are configured in one piece with one another.

25. Moulding according to claim 21, wherein at least one composite portion is arranged at an end region of the moulding.

26. Moulding according to claim 21, wherein the moulding has at least one flexible zone and at least one non-composite portion is arranged in the flexible zone.

27. Moulding according to claim 21, wherein the moulding has at least one rigid zone and at least one composite portion is arranged in the rigid zone.

28. Moulding according to claim 21, wherein in at least one composite portion, the reinforcement layer is secured in a material-uniting manner relative to the plastics material layer.

29. Moulding according to claim 21, wherein in at least one composite portion, the reinforcement layer is welded to the plastics material layer by means of a thermoplastic hot-melt adhesive.

30. Moulding according to claim 21, wherein in at least one composite portion, the reinforcement layer is vulcanised to the plastics material layer.

31. Moulding according to claim 21, wherein in at least one composite portion, the reinforcement layer is adhered to the plastics material layer by means of an adhesive.

32. Moulding according to claim 21, wherein at least one composite portion is formed by injection moulding.

33. Moulding according to claim 21, wherein the moulding is provided with at least one reinforcement ring.

34. Moulding according to claim 21, wherein at least one reinforcement ring is arranged in a non-composite portion of the moulding.

35. Moulding according to claim 33, wherein at least one reinforcement ring is arranged between the plastics material layer and the reinforcement layer.

36. Moulding according to claim 33, wherein at least one reinforcement ring surrounds the reinforcement layer.

37. Moulding according to claim 33, wherein the moulding is provided with a plurality of reinforcement rings, which are spaced apart from one another in the longitudinal direction of the moulding.

38. Moulding according to claim 37, wherein at least two reinforcement rings are connected to one another.

39. Moulding according to claim 33, wherein at least one reinforcement ring is configured in multiple parts.

40. Moulding according to claim 21, wherein in at least one non-composite portion, the reinforcement layer comprises a support material in the form of a woven fabric, hosiery fabric, knitted fabric, tangle fabric, braided fabric or a winding and the support material is provided with a rubber coating.

41. Assembly, comprising an exhaust gas turbocharger and an intercooler for an internal combustion engine and a hot-side charge-air line connecting the exhaust gas turbocharger to a charge-air inlet of the intercooler, characterised in that the hot-side charge-air line comprises a tubular moulding according to claims 1.

42. Method for producing a tubular moulding, comprising the following method steps:
arranging a hose, which is formed from a material containing a fluoropolymer material, and a support hose in a blow mould;
heating up the blow mould to a forming temperature;
producing a pressure difference between the interior of the hose and/or the interior of the support hose, on the one hand, and the region of the interior of the blow mould located outside the hose and the support hose, on the other hand, so that the hose and the support hose are pressed against the inner wall of the blow mould and together form a moulding with a wall, which comprises a composite of the hose and the support hose;
removing the moulding from the blow mould.

43. Method according to claim 42, wherein the interior of the hose and/or of the support hose is loaded with an increased pressure.

44. Method according to claim 42, wherein there is used a hose coated with a connecting material and/or a support hose coated with a connecting material.

45. Method according to claim 42, wherein a connecting material hose is arranged between the hose and the support hose.

46. Method according to claim 42, wherein the forming temperature is above the crystallite melting temperature of the material of the hose.

47. Method for producing a tubular moulding, comprising the following method steps:
producing a tubular moulding blank made of a material containing a fluoropolymer material;
connecting a support hose to the moulding blank to form a rigid bond in at least one composite portion, wherein the support hose, in at least one non-composite portion, is not connected to the moulding blank to form a rigid bond.

48. Method according to claim 47, wherein the support hose, in at least one composite portion is welded to the moulding blank by means of a thermoplastic hot-melt adhesive.

49. Method according to claim 47, wherein the support hose, in at least one composite portion, is vulcanised to the moulding blank.

50. Method according to claim 47, wherein the support hose, in at least one composite portion, is adhered to the moulding blank by means of an adhesive.

51. Method according to claim 47, wherein the moulding blank is produced by blow moulding.

52. Method according to claim 47, wherein the support hose is connected to the moulding blank after production of the moulding blank.

53. Method according to claim 47, wherein the support hose is connected to the moulding blank during production of the moulding blank.

54. Method according to claim 53, wherein the moulding blank is at least partially produced by injection moulding.
